(19) United States
(12) Patent Application Publication
(10) Pub. No.: US 2012/0252955 A1
(43) Pub. Date: Oct. 4, 2012

(54) LIQUID CRYSTAL POLYMER MOLDING AND METHOD FOR PRODUCING THE SAME

(75) Inventors: Satoshi SEKIMURA, Tsukuba-shi (JP); Hiroshi HARADA, Tsukuba-shi (JP)

(73) Assignee: SUMITOMO CHEMICAL COMPANY, LIMITED, Tokyo (JP)

(21) Appl. No.: 13/425,527

(22) Filed: Mar. 21, 2012

(30) Foreign Application Priority Data
Mar. 30, 2011 (JP) 2011-074858

(51) Int. Cl. C08K 3/40; B29C 45/72; B29C 45/00

(52) U.S. Cl. 524/494; 264/328.1; 264/328.14

(57) ABSTRACT

Provided is a liquid crystal polymer molding in which a weld portion has high strength and also surface properties are satisfactory. A method for producing a liquid crystal polymer molding including a weld portion by injection-molding a liquid crystal polymer composition containing a spherical filler, wherein the spherical filler has a center particle diameter of 60 μm or less, the method including molding so as to satisfy a relation: 20≦[thickness of the weld portion/center particle diameter of the spherical filler]≦55; and a liquid crystal polymer molding obtained by such a method.

### BACKGROUND OF THE INVENTION

1. Field of the Invention

The present invention relates to a liquid crystal polymer molding and a method for producing the same.

2. Description of the Related Art

A liquid crystal polymer, particularly a liquid crystal polymer having melt crystallinity has such features that it includes a rigid molecular frame and exhibits mesomorphism at the time of melting, and molecular chain orientation at the time of shear flow and extension flow. Because of such features, the liquid crystal polymer gives a molding which exhibits excellent fluidity in the case of subjecting to melt processing such as injection molding, extrusion molding, inflation molding or blow molding, and is also excellent in mechanical properties. Particularly, an aromatic liquid crystal polymer gives a molding which has, in addition to excellent fluidity at the time of molding, chemical stability and also high heat resistance, high strength and high rigidity which originate in a rigid molecular frame, and is therefore useful as an engineering plastic to which “light-weighting”, “thinning” and “downsizing” are required. It is particularly useful as electric and electronic components each including a thin wall portion which are subjected to a surface mounting step, and electric and electronic components each having high output and high capacity which are exposed to a high temperature when used, automotive members and the like.

However, the liquid crystal polymer has a problem that a weld portion of the obtained molding has remarkably low strength because of very large anisotropy and high solidification rate. Herein, the weld portion means a portion where two or more liquid crystal polymer melts flowing in a mold are welded as a result of junction in the case of injection molding. Thus, there is disclosed a method for producing a molding using a composition in which a liquid crystal polymer is mixed with a filler such as a glass fiber so as to reduce anisotropy and to increase the strength of the weld portion. However, this production method has a problem that large effect of improving the strength of the weld portion is not necessarily exerted, and also the surface of the molding is roughened, resulting in deterioration of surface properties.

To the contrary, JP-A-3-59067 discloses an optically anisotropic polyester resin composition, that is, a liquid crystal polymer composition composed of a specific ratio of an optically anisotropic polyester having a specific structure, a liquid crystal initiation temperature and a melt viscosity as a liquid crystal polymer having excellent heat resistance, moldability and fluidity and also having high mechanical properties, particularly high strength of a weld portion of a molding, and a specific ratio of a needle-shaped titanium oxide whisker and/or a needle-shaped aluminum borate whisker.

JP-A-3-281656 discloses that a liquid crystal polyester resin composition composed of a specific ratio of a liquid crystal polyester and a specific ratio of an aluminum borate whisker reduces the anisotropy of the liquid crystal polyester to improve the strength of a weld portion of a molding.

However, the compositions described in JP-A-3-59067 and JP-A-3-281656 also have a problem that the weld portion has insufficient strength and, in some cases, cracking occurs. There is also a problem that surface properties deteriorate, for example, roughening and a flow mark distinctly occur on a surface of the molding.

### SUMMARY OF THE INVENTION

Under the above-mentioned circumstances, the present invention has been made, and an object thereof is to provide a liquid crystal polymer molding in which a weld portion has a high strength and also surface properties are satisfactory.

In order to achieve the above object,

the present invention provides a method for producing a liquid crystal polymer molding comprising a weld portion by injection-molding a liquid crystal polymer composition containing a spherical filler, wherein the spherical filler has a center particle diameter of 60 μm or less, the method including molding so as to satisfy a relation: 20≦[thickness of the weld portion/center particle diameter of the spherical filler]≦55.

In the method for producing a liquid crystal polymer molding of the present invention, the liquid crystal polymer is preferably a liquid crystal polyester.

In the method for producing a liquid crystal polymer molding of the present invention, the liquid crystal polyester preferably includes a repeating unit derived from p-hydroxybenzoic acid in the proportion of 30 mol % or more based on the total amount of the whole repeating unit which constitutes the liquid crystal polyester.

In the method for producing a liquid crystal polymer molding of the present invention, injection molding is preferably performed under the conditions that an injection acceleration defined by dividing the maximum value of an injection rate by time required to reach the maximum value from initiation of the injection is from 1,000 to 25,000 mm/sec², and also the maximum value of injection pressure in a mold inlet is from 5 to 150 MPa in one injection molding.

In the method for producing a liquid crystal polymer molding of the present invention, injection molding is preferably performed under the conditions that a temperature of the liquid crystal polymer composition at the time of injection is adjusted to [flow initiation temperature of the liquid crystal polymer composition+20° C.] or higher and [flow initiation temperature of the liquid crystal polymer composition+80° C.] or lower.

In the method for producing a liquid crystal polymer molding of the present invention, a temperature of a mold at the time of injection molding is preferably adjusted to 80° C. or higher and [flow initiation temperature of the liquid crystal polymer composition−100° C.] or lower.

The present invention also provides a liquid crystal polymer molding obtained by the above method of the present invention.

According to the present invention, it is possible to provide a liquid crystal polymer molding in which a weld portion has a high strength and also surface properties are satisfactory.

### BRIEF DESCRIPTION OF THE DRAWINGS

FIG. 1 is a perspective view showing a molding according to one embodiment of the present invention.

### DETAILED DESCRIPTION OF THE INVENTION

The present invention will be described in detail below.

The method for producing a liquid crystal polymer molding of the present invention (hereinafter sometimes simply referred to as a molding) is directed to a method for producing a liquid crystal polymer molding including a weld portion by injection-molding a liquid crystal polymer composition containing a spherical filler, wherein the spherical filler has a center particle diameter of 60 μm or less, the method including molding so as to satisfy a relation: 20≦[thickness of the weld portion/center particle diameter of the spherical filler]≦55. The liquid crystal polymer molding of the present invention is characterized by being obtained by the above method.

In case two or more flows of a liquid crystal polymer composition, pressed into a mold when the liquid crystal polymer composition is subjected to injection molding, undergo junction in the mold, this junction site of the obtained molding becomes a weld portion integrated by welding. A typical example is observed in a molding including an opening portion. That is, the opening portion of the molding is formed by pressing a melt of a liquid crystal polymer composition into a mold from one (the upstream side) toward the other (the downstream side) using a mold provided with a structure for forming the opening portion inside. The liquid crystal polymer composition thus pressed into the mold hits against the structure thereby being divided into two fluids, which flow in the mold. After passing the structure, these two fluids join and thus the liquid crystal polymer composition surrounds the structure. Thus, the molding removed from the mold has an opening portion at the site where the structure existed. At this time, the weld portion exists from the site of the downstream side of the opening portion toward the downmost stream side (i.e., outside).

The weld portion is not necessarily confirmed visually from the surface side in the molding. However, in the molding of the present invention, the presence of the weld portion can be confirmed by observing a dispersion state and an arrangement state of a spherical filler in a cross section thereof using a microscope or the like, or by analyzing orientation of a liquid crystal polymer.

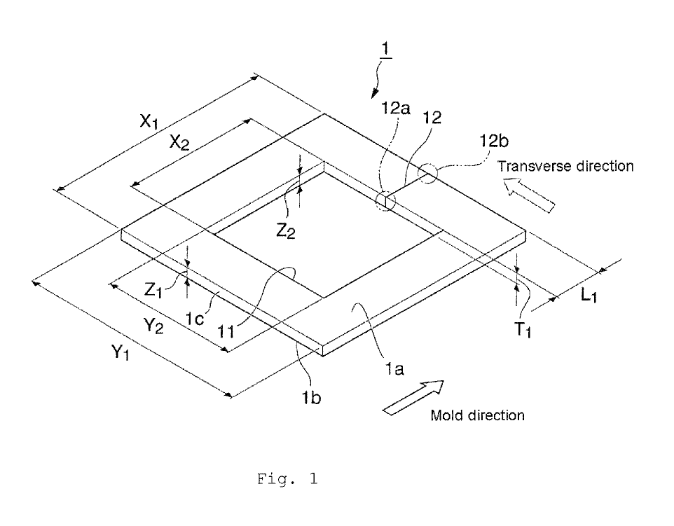

FIG. 1 is a perspective view showing a molding according to one embodiment of the present invention.

The molding 1 shown in the drawing has a shape of a thin plate with an opening portion 11, and also has a square external form and a square opening portion surface, which are similar to each other. The opening portion 11 is provided concentrically with the molding 1.

A melt of a liquid crystal polymer composition is pressed into a mold (not shown) in a direction indicated by arrow in FIG. 1, and a fluid of the liquid crystal polymer composition flows in the mold from the upstream side toward the downstream side and filled and molded, and thus the molding 1 is obtained.

A weld portion 12 extends from a part (site of the downstream side in a flow direction of the liquid crystal polymer composition) of the opening portion 11 toward the outside (i.e., the downmost stream side in a flow direction of the liquid crystal polymer composition) of the molding 1. One end 12a of the weld portion 12 overlaps with the opening portion 11. The other end 12b opposite to one end 12a of the weld portion 12 overlaps with an outer peripheral portion 1c of the molding 1.

Lengths X₁ and Y₁ of the side of the external form of the opened surface 1a and rear surface 1b of the molding 1, as well as a thickness Z₁ other than the opening portion 11 of the molding 1 can be optionally set. Herein, Z₁ represents a thickness in the outer peripheral portion 1c. X₂ and Y₂ of the side of the opened surface of the opening portion 11, as well as a thickness Z₂ can also be optionally set. Herein, any of Z₁ and Z₂ is a given value in the molding 1 and may be the value which varies depending on the site. Herein, Z₁ and Z₂ are the same as each other, and may be different with each other, and can be optionally set according to the purposes. The length L₁ along the surface 1a (or rear surface 1b) of the weld portion 12 becomes (X₁-X₂)/2.

The thickness of the weld portion 12 is T₁ and is a given value herein in the molding 1, and may be a value which varies depending on the site. Herein, T₁ denotes a thickness in the opening portion 11. Herein, T₁ and Z₂ are the same as each other, and may be different with each other. The value obtained by dividing T₁ by a center particle diameter M of a spherical filler, (T₁/M), is from 20 to 55, as described hereinafter.

The molding 1 was merely illustrated as an example of the liquid crystal polymer molding of the present invention and the liquid crystal polymer molding of the present invention is not limited thereto. For example, the external form of the molding and the shape of the opening portion surface may be other than quadrangle, and may be not similar to each other. The opening portion may not be concentrically with the molding. The other end of the weld portion may not be overlapped with the outer peripheral portion of the molding. The number of the opening portion and the weld portion may be other than one. If the weld portion exists, the number of the opening portion may be 0 (zero).

In the present invention, there is no particular limitation on the liquid crystal polymer, and the liquid crystal polymer is preferably a liquid crystal polyester.

The liquid crystal polyester is a liquid crystal polyester which exhibits mesomorphism in a melted state, and is preferably melted at a temperature of 450° C. or lower. The liquid crystal polyester may also be a liquid crystal polyester amide, a liquid crystal polyester ether, a liquid crystal polyester carbonate, or a liquid crystal polyester imide. The liquid crystal polyester is preferably a whole aromatic liquid crystal polyester in which only an aromatic compound is used as a raw material monomer.

Typical examples of the liquid crystal polyester include:

(I) those obtained by polymerizing (polycondensing) an aromatic hydroxycarboxylic acid, an aromatic dicarboxylic acid, and at least one kind of a compound selected from the group consisting of an aromatic diol, an aromatic hydroxylamine and an aromatic diamine;

(II) those obtained by polymerizing plural kinds of aromatic hydroxycarboxylic acids,

(III) those obtained by polymerizing an aromatic dicarboxylic acid with at least one kind of a compound selected from the group consisting of an aromatic diol, an aromatic hydroxylamine and an aromatic diamine,

(IV) those obtained by polymerizing a polyester such as polyethylene terephthalate with an aromatic hydroxycarboxylic acid. Herein, a polymerizable derivative of an aromatic hydroxycarboxylic acid, an aromatic dicarboxylic acid, an aromatic diol, an aromatic hydroxylamine and an aromatic diamine may be used, respectively independently, in place of a part or all thereof.

Examples of the polymerizable derivative of a compound having a carboxyl group, such as an aromatic hydroxycarboxylic acid and an aromatic dicarboxylic acid, include those in which a carboxyl group is converted into an alkoxycarbonyl group or an aryloxycarbonyl group (ester), those in which a carboxyl group is converted into a haloformyl group (acid halide), and those in which a carboxyl group is converted into an acyloxycarbonyl group (acid anhydride).

Examples of the polymerizable derivative of compound having a hydroxyl group, such as an aromatic hydroxycarboxylic acid, an aromatic diol and an aromatic hydroxylamine, include those in which a hydroxyl group is converted into an acyloxyl group by acylation (acylate).

Examples of the polymerizable derivative of a compound having an amino group, such as an aromatic hydroxylamine and an aromatic diamine, include those in which an amino group is converted into an acylamino group by acylation (acylate).

The liquid crystal polyester preferably includes a repeating unit represented by the following general formula (1) (hereinafter sometimes referred to as a “repeating unit (1)”), and more preferably includes a repeating unit (1), a repeating unit represented by the following general formula (2) (hereinafter sometimes referred to as a “repeating unit (2)”), and a repeating Unit represented by the following general formula (3) (hereinafter sometimes referred to as a “repeating unit (3)”):

—O—Ar¹—CO—, (1)

—CO—Ar²—CO—, and (2)

—X—Ar³—Y— (3)

wherein Ar¹ represents a phenylene group, a naphthylene group or a biphenylene group; Ar² and Ar³ each independently represents a phenylene group, a naphthylene group, a biphenylene group, or a group represented by the following general formula (4); X and Y each independently represents an oxygen atom or an imino group; and one or more hydrogen atoms in Ar¹, Ar² and Ar³ each independently may be substituted with a halogen atom, an alkyl group or an aryl group,

—Ar⁴—Z—Ar⁵— (4)

wherein Ar⁴ and Ar⁵ each independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom.

Examples of the alkyl group include a methyl group, an ethyl group, a n-propyl group, an isopropyl group, a n-butyl group, an isobutyl group, a sec-butyl group, a tert-butyl group, a n-pentyl group, a n-hexyl group, a n-heptyl group, a 2-ethylhexyl group, a n-octyl group, a n-nonyl group and a n-decyl group, and the number of carbon atoms is preferably from 1 to 10.

Examples of the aryl group include a phenyl group, an o-tolyl group, a m-tolyl group, a p-tolyl group, a 1-naphthyl group and a 2-naphthyl group, and the number of carbon atoms is preferably from 6 to 20.

When the hydrogen atom is substituted with these groups, the number thereof is preferably 2 or less, and more preferably 1 or less, every group represented by Ar¹, Ar² or Ar³, respectively, independently.

Examples of the alkylidene group include a methylene group, an ethylidene group, an isopropylidene group, a n-butylidene group and a 2-ethylhexylidene group, and the number of carbon atoms is preferably from 1 to 10.

The repeating unit (1) is a repeating unit derived from a predetermined aromatic hydroxycarboxylic acid. The repeating unit (1) is preferably a repeating unit in which Ar¹ is a p-phenylene group (a repeating unit derived from p-hydroxybenzoic acid), or a repeating unit in which Ar¹ is a 2,6-naphthylene group (a repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (a repeating unit derived from terephthalic acid), a repeating unit in which Ar² is a m-phenylene group (a repeating unit derived from isophthalic acid), a repeating unit in which Ar² is a 2,6-naphthylene group (a repeating unit derived from 2,6-naphthalenedicarboxylic acid), or a repeating unit in which Ar² is a diphenylether-4,4′-diyl group (a repeating unit derived from diphenylether-4,4′-dicarboxylic acid).

The repeating unit (3) is a repeating unit derived from a predetermined aromatic diol, aromatic hydroxylamine or aromatic diamine. The repeating unit (3) is preferably a repeating unit in which Ar³ is a p-phenylene group (a repeating unit derived from hydroquinone, p-aminophenol or p-phenylenediamine), or a repeating unit in which Ar³ is a 4,4′-biphenylene group (a repeating unit derived from 4,4′-dihydroxybiphenyl, 4-amino-4′-hydroxybiphenyl or 4,4′-diaminobiphenyl).

The content of the repeating unit (1) is preferably 30 mol % or more, more preferably 30 to 80 mol %, still more preferably 40 to 70 mol %, and particularly preferably 45 to 65 mol %, based on the total amount of the whole repeating unit constituting the liquid crystal polyester (value in which the mass of each repeating unit constituting a liquid crystal polyester is divided by the formula weight of each repeating unit to obtain an amount (mol) equivalent to the amount of a substance of each repeating unit, and then masses thus obtained are totalized).

The content of the repeating unit (2) is preferably 35 mol % or less, more preferably from 10 to 35 mol %, still more preferably from 15 to 30 mol %, and particularly preferably from 17.5 to 27.5 mol %, based on the total amount of the whole repeating unit constituting the liquid crystal polyester.

The content of the repeating unit (3) is preferably 35 mol % or less, more preferably from 10 to 35 mol %, still more preferably from 15 to 30 mol %, and particularly preferably from 17.5 to 27.5 mol %, based on the total amount of the whole repeating unit constituting the liquid crystal polyester.

As the content of the repeating unit (1) increases, melt fluidity, heat resistance, strength and rigidity are likely to be improved. However, when the content is too large, melting temperature and melt viscosity are likely to increase and the temperature required to molding is likely to increase.

The liquid crystal polyester preferably includes a repeating unit derived from p-hydroxybenzoic acid in the proportion of 30 mol % or more based on the total amount of the whole repeating unit constituting the liquid crystal polyester.

The ratio of the content of the repeating unit (2) to the content of the repeating unit (3) is preferably from 0.9/1 to 1/0.9, more preferably from 0.95/1 to 1/0.95, and still more preferably from 0.98/1 to 1/0.98, in terms of [content of the repeating unit (2)]/[content of the repeating unit (3)] (mol/mol).

The liquid crystal polyester may include two or more kinds of the repeating units (1) to (3), respectively, independently. The liquid crystal polyester may include repeating units other than the repeating units (1) to (3), and the content thereof is preferably 10 mol % or less, and more preferably 5 mol % or less, based on the total amount of the whole repeating unit constituting the liquid crystal polyester.

The liquid crystal polyester preferably includes, as the repeating unit (3), those in which X and Y are respectively oxygen atoms, that is, a repeating unit derived from a predetermined aromatic diol, and more preferably includes, as the repeating unit (3), only those in which X and Y are respectively oxygen atoms. Consequently, the melt viscosity of the liquid crystal polyester is likely to decrease.

The liquid crystal polyester is preferably produced by melt-polymerizing a raw material monomer corresponding to a repeating unit constituting the liquid crystal polyester, and then subjecting the obtained polymer (prepolymer) to solid phase polymerization. This makes it possible to produce a high molecular weight liquid crystal polyester having heat resistance as well as high strength and rigidity with satisfactory operability. The melt polymerization may be performed in the presence of a catalyst. In this case, examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among these catalysts, nitrogen-containing heterocyclic compounds are preferably used.

The flow initiation temperature of the liquid crystal polyester is preferably 270° C. or higher, more preferably from 270° C. to 400° C., and still more preferably from 280° C. to 380° C. As the flow initiation temperature increases, heat resistance as well as strength and rigidity are likely to be improved. When the flow initiation temperature is too high, the melting temperature and the melt viscosity are likely to increases and the temperature required to molding is likely to increase.

The flow initiation temperature is also referred to as a flow temperature and means a temperature at which the melt viscosity becomes 4,800 Pa·s (48,000 poise) when a liquid crystal polyester is melted while heating at a heating rate of 4° C./minute under a load of 9.8 MPa (100 kg/cm²) and extruded through a nozzle having an inner diameter of 1 mm and a length of 10 mm using a capillary rheometer, and the flow initiation temperature serves as an index indicating the molecular weight of the liquid crystal polyester (see “Liquid Crystalline Polymer-Synthesis, Molding, and Application” edited by Naoyuki Koide, page 95, published by CMC on Jun. 5, 1987).

When other liquid crystal polymers, or liquid crystal polymer compositions are used in place of the liquid crystal polyester, these flow initiation temperatures can be measured in the same manner as described above.

The spherical filler to be used in the preparation of the liquid crystal polymer composition is a particle-shaped filler which does not extend in a specific direction, such as a fiber-shaped filler, a plate-shaped filler and a strip-shaped filler, and the average sphericity thereof is preferably 3 or less, more preferably from 1 to 2, still more preferably from 1 to 1.5, and particularly preferably from 1 to 1.2. As used herein, the average sphericity means an average of sphericities, which is obtained by selecting 30 fillers at random from a lot of fillers, observing the fillers, measuring a maximum length D1 and minimum length D2 of each filler, and then determining a value of D1/D2 as the sphericity. Observation can be performed, for example, by projecting using a profile projector, or using a high magnification stereo microscope.

The center particle diameter of the spherical filler is 60 μm or less and, when it is more than 60 μm, a surface of the molding is roughened and thus surface properties deteriorate. The center particle diameter of the spherical filler is preferably 0.01 μm or more, whereby, the strength of the weld portion of the molding is more improved. From the viewpoint of more improvement of the strength of the weld portion and surface properties, the center particle diameter of the spherical filler is more preferably from 1 to 60 μm, and still more preferably from 10 to 60 μm.

The center particle diameter means a median diameter D50, and means a numerical value in which when the particle diameter is bipolarized, the amount of particles with a large particle diameter becomes the same as that of particles with a small particle diameter.

Specific examples of the spherical filler include those made of glasses such as glass beads, glass powder and hollow glass; and those made of materials, for example, kaolin, clay, vermiculite; silicates such as calcium silicate, aluminum silicate, a feldspar powder, acid clay, pyrophyllite clay, sericite, sillimanite, bentonite, a slate powder and silane; carbonates such as calcium carbonate, whitewash, barium carbonate, magnesium carbonate and dolomite; sulfates such as a baryta powder, blanc fixe, precipitated calcium sulfate, calcined gypsum and barium sulfate; hydroxides such as hydrated alumina; oxides such as alumina, antimony oxide, magnesia, titanium oxide, zinc oxide, silica, quartz sand, quartz, white carbon and diatomaceous earth; sulfides such as molybdenum disulfide; metal particulate matters; organic polymers such as a fluorine resin; and organic low molecular weight crystals such as brominated diphenylether; and also include particulate matters having a small aspect ratio. These spherical fillers may be used alone, or two or more kinds may be used in combination. Among these fillers, glass beads and hollow glass are typical spherical fillers.

There is no particular limitation on the content of the spherical filler of the liquid crystal polymer composition. In order to improve surface properties and the strength of the weld portion while maintaining fluidity of the liquid crystal polymer composition without causing deterioration of features such as strength and dimensional stability of the molding, the content is preferably from 1 to 70% by mass. When the content is adjusted to the lower limit or more, surface properties and the strength of the weld portion are more improved. When the content is adjusted to the upper limit or less, fluidity of the liquid crystal polymer composition is improved and moldability becomes more satisfactory, and also mechanical properties of the molding are improved. From the viewpoint of effectively improving surface properties and the strength of the weld portion while maintaining satisfactory moldability, the content of the spherical filler is more preferably from 20 to 60% by mass, and still more preferably from 25 to 50% by mass.

The liquid crystal polymer composition may contain one or more other components such as fillers other than the spherical filler, additives and resins other than the liquid crystal polymer as long as the object of the present invention is not impaired.

Fillers other than the spherical filler may be fiber-shaped fillers, plate-shaped fillers, or particle-shaped filler other than fiber-shaped and plate-shaped fillers. The fillers may be inorganic fillers, or organic fillers.

Examples of the fiber-shaped inorganic filler include glass fibers; carbon fibers such as a PAN-based carbon fiber and a pitch-based carbon fiber; ceramic fibers such as a silica fiber, an alumina fiber and a silica alumina fiber; and metal fibers such as a stainless steel fiber. Examples thereof also include whiskers such as a potassium titanate whisker, a barium titanate whisker, a wollastonite whisker, an aluminum borate whisker, a silicon nitride whisker and a silicon carbide whisker.

Examples of the fiber-shaped organic filler include a polyester fiber and an aramide fiber.

Examples of the plate-shaped inorganic filler include talc, mica, graphite, wollastonite, glass flake, barium sulfate and calcium carbonate. Mica may be muscovite, phlogopite, fluorphlogopite or tetrasilicic mica.

Examples of the particle-shaped inorganic filler include silica, alumina, titanium oxide, boron nitride, silicon carbide and calcium carbonate.

The content of the filler is preferably from 0 to 100 parts by mass based on 100 parts by mass of the liquid crystal polymer.

Examples of the additive include an antioxidant, a heat stabilizer, an ultraviolet absorber, an antistatic agent, a surfactant, a flame retardant, a lubricant, a releasant and a colorant.

The content of the additive is preferably from 0 to 5 parts by mass based on 100 parts by mass of the liquid crystal polymer.

Examples of the resin other than the liquid crystal polymer include thermoplastic resins such as polypropylene, polyamide, polyester, polysulfone, polyphenylene sulfide, polyetherketone, polycarbonate, polyphenylene ether and polyetherimide; and thermosetting resins which do not correspond to the liquid crystal polymer, such as a phenol resin, an epoxy resin, a polyimide resin and a cyanate resin.

The content of the resin other than the liquid crystal polymer is preferably from 0 to 20 parts by mass based on 100 parts by mass of the liquid crystal polymer.

The liquid crystal polymer composition is preferably prepared by melt-kneading the liquid crystal polymer, the spherical filler and optionally usable other components using an'extruder, and then extruding the melt-kneaded mixture into pellets. As the extruder, an extruder including a cylinder, one or more screws disposed in the cylinder, and one or more supply ports provided in the cylinder is preferably used, and an extruder further including one or more vent portions provided in the cylinder is more preferably used.

The molding of the present invention satisfies a relation: 20≦[thickness of the weld portion/center particle diameter of the spherical filler]≦55, preferably a relation: 21.5≦[thickness of the weld portion/center particle diameter of the spherical filler]≦53.5, and more preferably 23≦[thickness of the weld portion/center particle diameter of the spherical filler]≦52. By adjusting the above value to the lower limit or more, the strength of the weld portion is improved. Also, fluidity of the liquid crystal polymer composition at the time of molding is improved and moldability becomes satisfactory, and also mechanical properties of the molding are improved. By adjusting the above value to the upper limit or less, the strength of the weld portion is improved.

It is not necessary that the whole thickness of the molding of the present invention is the same, and the molding preferably satisfies a relation: 20≦[thickness of the molding/center particle diameter of the spherical filler]≦55, more preferably a relation: 21.5≦[thickness of the molding/center particle diameter of the spherical filler]≦53.5, and still more preferably a relation: 23≦[thickness of the molding/center particle diameter of the spherical filler]≦52. By adjusting the above value to the lower limit or more, fluidity of the liquid crystal polymer composition at the time of molding is improved and moldability becomes satisfactory, and also properties such as mechanical strength of the molding are more improved. By adjusting the above value to the upper limit or less, mechanical strength of the molding is more improved.

In the case of subjecting the liquid crystal polymer composition to injection molding, molding may be performed using a selected mold having a desired shape, which can control the thickness of a weld portion such that the value of [thickness of the weld portion/center particle diameter of the spherical filler] falls within the above range according to the center particle diameter of the spherical filler.

In the case of subjecting the liquid crystal polymer composition to injection molding, injection acceleration defined by dividing the maximum value of an injection rate Vₘₐₓ by time required to reach the maximum value from initiation of the injection t₁ (Vₘₐₓ/t₁) is preferably adjusted within a range from 1,000 to 25,000 mm/sec², in one injection molding. The injection rate may be observed, for example, by a waveform monitor.

Surface properties of the molding and strength of the weld portion are more improved by adjusting the injection acceleration to the lower limit value or more. By adjusting it to the upper limit value or less, a special machine as an injection molding machine becomes unnecessary and thus versatility is improved.

In the case of subjecting the liquid crystal polymer composition to injection molding, the maximum value of injection pressure in a mold inlet is preferably adjusted within a range from 5 to 150 MPa in one injection molding. The injection pressure may be read, for example, from the pressure waveform.

Surface properties of the molding and strength of the weld portion are more improved by adjusting the injection pressure to the lower limit value or more. By adjusting it to the upper limit value or less, the occurrence of burr in the molding is suppressed, and also removal of the molding from the mold is facilitated. Therefore, cracking of the weld portion associated with deformation of the molding at the time of mold removal is suppressed.

In the present invention, when the liquid crystal polymer composition is subjected to injection molding, both the injection acceleration and the injection pressure are preferably adjusted to the numerical values within the above range.

When the liquid crystal polymer composition is subjected to injection molding, it is preferred that the flow initiation temperature of the liquid crystal polymer composition is determined by the below-mentioned method, first, and then the temperature (actual temperature of the liquid crystal polymer composition in a melted state) of the liquid crystal polymer composition at the time of injection is adjusted to [flow initiation temperature of the liquid crystal polymer composition+20° C.] or higher and [flow initiation temperature of the liquid crystal polymer composition+80° C.] or lower.

By adjusting the temperature to the lower limit value or more, roughening of a surface of the obtained molding is suppressed and thus surface properties are more improved. Furthermore, the cracking suppressing effect of the weld portion is more improved. By adjusting it to the upper limit value or less, decomposition of the liquid crystal polymer retained in the molding machine is suppressed and thus the surface properties of the molding are more improved. Furthermore, outflow of the melted resin through a nozzle is suppressed at the time of removal of the molding from the mold after molding is suppressed and thus productivity of the molding is more improved.

From the viewpoint of more improving the strength of the weld portion and moldability, the temperature of the liquid crystal polymer composition at the time of injection is preferably adjusted to [flow initiation temperature of the liquid crystal polymer composition+30° C.] or higher and [flow initiation temperature of the liquid crystal polymer composition+60° C.] or lower.

When the liquid crystal polymer composition is subjected to injection molding, the temperature of the mold is preferably adjusted to 80° C. or higher. Consequently, surface properties of the obtained molding are more improved.

When the liquid crystal polymer composition is subjected to injection molding, the upper limit value of the temperature of the mold is preferably adjusted appropriately according to the kind of liquid crystal polymer composition so as to prevent decomposition of the liquid crystal polymer composition, and more preferably adjusted to [flow initiation temperature of the liquid crystal polymer composition−50° C.]. Consequently, the cooling time of the mold after molding can be shortened and thus productivity is improved. Furthermore, removal of the molding from the mold is facilitated and thus deformation of the molding is suppressed. Furthermore, since mutual engagement of molds is improved, breakage of the molding at the time of opening and closing of the mold is suppressed.

Since the above-mentioned effect is exerted more remarkably, the temperature of the mold is preferably adjusted to 80° C. or higher and [flow initiation temperature of the liquid crystal polymer composition−100° C.] or lower, more preferably 1,000° C. or higher and [flow initiation temperature of the liquid crystal polymer composition−100° C.] or lower, and still more preferably 130° C. or higher and [flow initiation temperature of the liquid crystal polymer composition−100° C.] or lower.

A method for determining more practical injection molding conditions will be described below. In the present method, an optionally selected flat plate-shaped molding is regarded as a standard molding. The standard molding is produced by injection-molding while varying molding conditions, and the injection molding conditions are optimized by performing a bending strength test of the weld portion thereof. To take an instance, first, the temperature of a liquid crystal polymer composition at the time of injection is adjusted to a suitable range (for example, [flow initiation temperature of the liquid crystal polymer composition+20° C.] or higher and [flow initiation temperature of the liquid crystal polymer composition+80° C.] or lower), injection acceleration is adjusted to a suitable range (for example, 1,000 to 25,000 mm/sec²), the maximum value of injection pressure in a mold inlet is adjusted to a suitable range (for example, 5 to 150 MPa) and the temperature of a mold is adjusted to 80° C., and then injection molding is performed to produce a standard molding. Test pieces including a weld portion are cut out form the obtained standard molding, and then a bending strength test of the weld portion is performed and the strength thereof is measured. Furthermore, surface properties of the molding are evaluated by, for example, measuring roughness using a surface roughness meter. Then, the temperature of the mold is set to a predetermined temperature of 80° C. or higher and a standard molding is produced in the same manner as described above. The measurement of the strength of the weld portion and evaluation of the surface properties of the molding are performed, and this operation is repeated at various temperatures. The temperature of the mold is set to a predetermined temperature of 80° C. or lower, and the same operation is repeated. As described above, the temperature of the mold can be optimized from the results of the measurement of the strength of the weld portion and the evaluation of the surface properties of the molding. While the method of optimizing the temperature of the mold was described herein, the temperature of the liquid crystal polymer composition, injection acceleration, and the maximum value of injection pressure in a mold inlet at the time of injection can be easily optimized in the same manner as described above. The bending strength of the weld portion is preferably 15 MPa or more, more preferably 20 MPa or more, and still more preferably 25 MPa or more.

After determining the practical injection molding conditions by the above-mentioned method, molding may be performed after replacing the mold by a mold for obtaining the objective molding.

While the method using a standard molding was described herein, if the measurement of the strength of the weld portion and the evaluation of the surface properties of the molding can be performed in the objective molding, practical injection molding conditions may be determined using this molding.

The molding of the present invention is suitable for various products or components which are required to have high heat resistance, high strength and high rigidity, for example, bobbins such as an optical pickup bobbin and a trans bobbin; relay components such as a relay case, a relay base, a relay sprue and a relay armature; reflectors such as a lamp reflector and an LED reflector; holders such as a heater holder; diaphragms such as a speaker diaphragm; separation claws such as a separation claw for copying machine, and a separation claw for printer; module components of cameras including a compact camera; switch components; motor components; sensor components; hard disk drive components; tablewares such as an oven ware; vehicle components; aircraft components; and sealing members such as a sealing member for semiconductor device, and a sealing member for coil.

In the molding of the present invention, roughening of a surface and occurrence of a flow mark are suppressed and surface properties are excellent since a spherical filler is used. By limiting the center particle diameter of the spherical filler within a specific range limited depending on the thickness of the weld portion, the strength of the weld portion is high. As described above, the molding of the present invention is different from a conventional molding in that an improvement of the strength of the weld portion was achieved without causing deterioration of surface properties.

### EXAMPLES

The present invention will be described in more detail by way of specific examples. However, the present invention is not limited to the following examples. The flow initiation temperatures of a liquid crystal polyester and the flow initiation temperatures of a liquid crystal polyester composition were measured by the following methods.

### (Measurement of Flow Initiation Temperatures of Liquid Crystal Polyester and Flow Initiation Temperatures of Liquid Crystal Polyester Composition)

Using a flow tester (Model CFT-500, manufactured by Shimadzu Corporation), about 2 g of a liquid crystal polyester or liquid crystal polyester composition was filled in a cylinder with a die including a nozzle having an inner diameter of 1 mm and a length of 10 mm attached thereto, and the liquid crystal polyester or liquid crystal polyester composition was melted while raising a temperature at a rate of 4° C./minute under a load of 9.8 MPa (100 kg/cm²) and extruded through the nozzle, and then the temperature at which the extrudate showed a viscosity of 4,800 Pa·s (48,000 poise) was measured.

### Production of Liquid Crystal Polyester

### Production Example 1

In a reactor equipped with a stirrer, a torque meter, a nitrogen gas introducing tube, a thermometer and a reflux condenser, 994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl, 1347.6 g (13.2 mol) of acetic anhydride and 0.194 g of 1-methylimidazole were charged. While stirring under a nitrogen gas flow, the temperature was raised from room temperature to 145° C. over 30 minutes and then the mixture was refluxed at 145° C. for 1 hour. Then, the temperature was raised from 145° C. to 320° C. over 2 hours and 50 minutes while distilling off the by-produced acetic acid and unreacted acetic anhydride. After maintaining at 320° C. for 1 hour, contents were taken out form the reactor and then cooled to room temperature. The obtained solid substance was ground by a grinder to obtain a powdered prepolymer. The prepolymer had a flow initiation temperature of 261° C. Then, the prepolymer was subjected to solid phase polymerization by raising the temperature from room temperature to 250° C. over 1 hour under a nitrogen gas atmosphere, raising temperature from 250° C. to 285° C. over 5 hours and maintaining at 285° C. for 3 hours, and then cooling to obtain a powdered liquid crystal polyester (LCP1). The liquid crystal polyester had a flow initiation temperature of 327° C.

### Production of Liquid Crystal Polyester Composition

### Production Example 2

The liquid crystal polyester (LCP1) obtained in Production Example 1 was mixed with the below-mentioned fillers in accordance with the composition shown in Table 1, and then the mixture was granulated at a cylinder temperature of 340° C., using a twin screw extruder (PCM-30, manufactured by Ikegai Iron Works, Ltd.) to obtain pellets of a liquid crystal polyester composition. The measurement results of the flow initiation temperature (FT: flow temperature) of the obtained pellets are shown in Table 1.

### (Spherical Filler)

Glass beads (GB1): EGB731-PN (size publicated by manufacturer: center particle diameter of 20 μm), manufactured by Potters-Ballotini Co., Ltd.

Glass beads (GB2): EGB210 (size publicated by manufacturer: center particle diameter of 18 μm), manufactured by Potters-Ballotini Co., Ltd.

Glass beads (GB3): EMB20 (size publicated by manufacturer: center particle diameter of 10 μm), manufactured by Potters-Ballotini Co., Ltd.

Glass beads (GB4): EMB10 (size publicated by manufacturer: center particle diameter of 5 μm), manufactured by Potters-Ballotini Co., Ltd.

Glass beads (GB5): UB26E (size publicated by manufacturer: center particle diameter of 75 μm), manufactured by Unitika Limited.

### Production of Liquid Crystal Polyester Molding

### Examples 1 to 3 and Comparative Examples 1 to 2

After drying the pellets of the liquid crystal polyester compositions obtained above at 120° C. for 3 hours, liquid crystal polyester moldings (test piece for evaluation of weld portion) shown in FIG. 1 were produced using an injection molding machine, Model UH-1,000, manufactured by Nissei Resin Industry Co. Ltd., under the conditions shown in Table 1. The size of each molding in FIG. 1 was as follows: X₁=Y₁=64 mm, Z₁=0.5 mm, X₂=Y₂=38 mm, and Z₂=T₁=0.5 mm. At this time, the maximum value of an injection rate, an attack time and shock pressure (maximum value of injection pressure in a mold inlet) were measured by a waveform monitor to determine injection acceleration. With respect to the obtained molding, the surface properties thereof were evaluated, and the bending strength of the weld portion was measured by the following procedures. The results are shown in Table 1. Also, thickness of the weld portion of the molding, center particle diameter of the spherical filler, and value of [thickness of the weld portion/center particle diameter of the spherical filler] are respectively shown in Table 1 (see “thickness”, “center particle diameter of spherical filler”, and “thickness/center particle diameter]”.

### (Evaluation of Surface Properties of Liquid Crystal Polyester Molding)

The presence or absence of roughening and a flow mark was evaluated by visually observing a surface of a molding.

### (Measurement of Bending Strength of Weld Portion)

A region including a weld portion (segment of 13 mm×64 mm×0.5 mm in size) at the downstream side of an opening portion thereof is cut out from the molding, and a three-point bending test was carried out under the conditions of a spun of 40 mm and a bending rate of 2 mm/minute using a universal testing machine, and then a breaking strength was measured.

TABLE 1

| | | | | Molding | | | |
|---|---|---|---|---|---|---|---|
| | Liquid crystal polymer | | | | Center | | |
| | composition | | | | particle | | |
| | Liquid | | | | diameter | | Bending |
| | crystal | Spherical | Fluid | | of | | strength |
| | polymer | filler | initiation | | spherical | Thickness/center | of weld |
| | (% by | (parts by | temperature | Thickness | filler | particle | portion |
| | mass) | mass) | (° C.) | (μm) | (μm) | diameter | (MPa) |
| Example 1 | LCP1 | GB3 | 323 | 500 | 10 | 50 | 47 |
| | (100) | (67) | | | | | |
| Example 2 | LCP1 | GB2 | 322 | 500 | 18 | 28 | 49 |
| | (100) | (67) | | | | | |
| Example 3 | LCP1 | GB1 | 322 | 500 | 20 | 25 | 48 |
| | (100) | (67) | | | | | |
| Comparative | LCP1 | GB4 | 323 | 500 | 5 | 100 | 44 |
| Example 1 | (100) | (67) | | | | | |
| Comparative | LCP1 | GB5 | 321 | 500 | 75 | 7 | 45 |
| Example 2 | (100) | (67) | | | | | |

As is apparent from the above results, the weld portion of the moldings of Examples 1 to 3 had sufficient strength. Neither noticeable roughening nor flow mark was observed on a surface and thus surface properties were satisfactory. To the contrary, the weld portion of the moldings of Examples 1 to 2 had insufficient strength. A flow mark was visually observed on a surface and also surface roughening was often observed at the flow mark portion.

The present invention can be used in electric and electronic components each including a thin wall portion, and electric and electronic components each including high output and high capacity which are exposed to a high temperature when used, automotive members and the like.

What is claimed is:

1. A method for producing a liquid crystal polymer molding comprising a weld portion by injection-molding a liquid crystal polymer composition containing a spherical filler, wherein
the spherical filler has a center particle diameter of 60 μm or less, the method comprising molding so as to satisfy a relation:
20≦[thickness of the weld portion/center particle diameter of the spherical filler]≦55.

2. The method for producing a liquid crystal polymer molding according to claim 1, wherein the liquid crystal polymer is a liquid crystal polyester.

3. The method for producing a liquid crystal polymer molding according to claim 2, wherein the liquid crystal polyester includes a repeating unit derived from p-hydroxybenzoic acid in the proportion of 30 mol % or more based on the total amount of the whole repeating unit which constitutes the liquid crystal polyester.

4. The method for producing a liquid crystal polymer molding according to claim 1, wherein injection molding is performed under the conditions that injection acceleration defined by dividing the maximum value of an injection rate by time required to reach the maximum value from initiation of the injection is adjusted to 1,000 to 25,000 mm/sec², and also the maximum value of injection pressure in a mold inlet is adjusted to 5 to 150 MPa in one injection molding.

5. The method for producing the liquid crystal polymer molding according to claim 1, wherein injection molding is performed under the conditions that the temperature of the liquid crystal polymer composition at the time of injection is adjusted to [flow initiation temperature of the liquid crystal polymer composition+20° C.] or higher and [flow initiation temperature of the liquid crystal polymer composition+80° C.] or lower.

6. The method for producing the liquid crystal polymer molding according to claim 1, wherein the temperature of a mold at the time of injection molding is adjusted to 80° C. or higher and [flow initiation temperature of the liquid crystal polymer composition−100° C.] or lower.

7. A liquid crystal polymer molding obtained by the method according to claim 1.
